(19) United States
(12) Patent Application Publication
(10) Pub. No.: US 2024/0165631 A1
(43) Pub. Date: May 23, 2024

(54) AGITATOR MILL COMPRISING BASKET COMPRISING SLITS

(71) Applicant: Netzsch-Feinmahltechnik GmbH, Selb (DE)

(72) Inventors: Robert Grandl, Selb (DE); Lars-Peter Weiland, Schönwald (DE); Holger Moeschl, Selb (DE); Witali Sudermann, Marktredwitz (DE)

(21) Appl. No.: 18/507,799

(22) Filed: Nov. 13, 2023

(30) Foreign Application Priority Data
Nov. 17, 2022 (DE) 10 2022 130 383.7

(51) Int. Cl. B02C 17/16; B02C 17/18

(52) U.S. Cl. CPC B02C 17/168; B02C 17/18

(57) ABSTRACT

An agitator mill including a grinding chamber containing grinding bodies and an agitator shaft, which revolves therein about a horizontal agitator shaft axis, which supports several grinding members, which are connected to it in a rotationally fixed manner and which are spaced apart from one another in the direction of the horizontal axis, preferably in the shape of grinding disks, which move the grinding bodies, whereby, on the outlet side, the agitator shaft has a basket, which is preferably studded with grinding members on its outer circumference and which overlaps the split tube-supporting outlet, whereby a separation chamber is formed between the inner surface of the basket and the split tube-supporting outlet, whereby the basket has slits for returning grinding bodies from the separation chamber into the grinding chamber, which slits lead into the free front surface of the basket, which faces away from the grinding chamber.

### TECHNICAL FIELD

The invention relates to an agitator mill comprising a basket comprising slits and the corresponding basket according to the claims.

### BACKGROUND

The basic principle of an agitator mill will initially be described on the basis of FIG. 1.

An agitator mill 1 comprising a horizontal agitator shaft 3 is illustrated schematically in FIG. 1. The illustration of the grinding bodies, which are located in the grinding container 16 and which are generally embodied as steel or ceramic balls, was forgone.

During the operation of the agitator mill 1, the material to be ground is pumped via the inlet 17 of the agitator mill 1 into or through the grinding chamber 2, respectively, which is enclosed by the grinding container 16. In the case of the wet grinding, the material to be ground is a suspension or dispersion, respectively, of a liquid, mostly in the form of water, and solids. In other cases, such an agitator mill 1 can also be used for the dry grinding. It can then be designed for instance as agitator mill comprising a vertical shaft, through which the grinding material is carried by a gaseous fluid, mostly in downflow.

In its broadest aspect, the present invention relates to both types of agitator mills. Its use is particularly preferred in the case of agitator mills comprising a horizontal agitator shaft 3.

The grinding members 5, which are connected in a rotationally fixed manner to the agitator shaft 3 and which are often also embodied and referred to as grinding disks, are set into rotation by means of a rotational movement of the agitator shaft 3. The formation of the grinding members 5 in the form of individual pins is likewise possible, also as part of the invention, which will be described below. To create the rotational movement, the agitator shaft 3 can be driven, for example, via a belt drive 102 by means of an electric motor 101. The drive of the agitator mill 1 is thereby mostly located in a housing 103 adjacent to the grinding container 16.

Due to the rotation of the grinding members 5, the grinding bodies, which are located in the grinding chamber 2 and which are located in the vicinity of the grinding members 5, are entrained in the circumferential direction of the grinding container 16. As soon as they have reached the apex region, the moved grinding bodies flow back in the direction of the agitator shaft 3 again in the central region between two respective grinding members 5. A circulation movement of the grinding bodies is thus created between two respective grinding members 5.

Collisions and roll-overs between the solids of the grinding material suspension pumped through the grinding chamber 2 and the grinding bodies is caused due to the movement of the grinding bodies. These collisions and roll-overs lead to the splintering of fine particles from the solids in the grinding material suspension, so that the solids arriving at the outlet 7 of the agitator mill 1 are ultimately significantly smaller than the solids supplied on the inlet 17.

In order to ensure that grinding bodies are not discharged from the grinding chamber, a screen or preferably a screen in the shape of a split tube 8, respectively, representatively referred to below as “split tube”, is mostly also attached in front of the outlet 7 and/or supported by the outlet 7. A basket 6 encompassing this split tube 8 is arranged around this split tube 8. The basket serves the purpose of preventing that damaging grinding body pressure is exerted on the split tube by the grinding bodies, which tend to be pushed in the direction of the split tube by the pressure of the feed pump.

For the most part, the basket 6 is attached in a rotationally fixed manner on the free end of the agitator shaft 3 facing the outlet 7.

The region between the circumferential basket 6 and the split tube 8 forms the separation chamber 9 because the material to be ground or the grinding material suspension, respectively, is separated from the grinding bodies here and lastly escapes from the agitator mill 1 again via the split tube 8 and the outlet 7.

As a rule, the basket 6, however, can only fulfill its function when grinding bodies, which have entered into the separation chamber 9, are able to also get out of the separation chamber again, back into the grinding chamber 2. This is so because otherwise the separation chamber 9 is quickly filled up with grinding bodies and the grinding bodies then block the split tube and possibly allow it to even wear prematurely.

In order to prevent this, various apertures 104 are provided in the basket 6. Due to these apertures 104, the grinding bodies can pass from the separation chamber 9 into the grinding chamber 2 again more easily. FIG. 2 shows a basket 6, which is designed in this way, of an agitator mill, which served as test or comparative object, respectively, in the lead-up to the invention. The grinding body and/or grinding material flows, which have already been mentioned and which take place in the grinding container 16, are illustrated schematically thereby in FIG. 2. As can be seen, the basket 6 preferably likewise supports, on its outer jacket surface, grinding members 5, which cause a movement or a circling, respectively, of the grinding bodies in the region between the basket and the inner wall of the grinding container 16. This circling of the grinding bodies makes it easier for the grinding bodies located in the separation chamber 9 to escape through the apertures 104 into the grinding chamber 2 again.

The inventors have determined, however, that in the case of the basket construction shown in FIG. 2, there is also still a certain tendency of the grinding bodies, which entered into the separation chamber 9, to attach tightly to the split tube 8 and to block the split tube 8 or to even cause unnecessary wear. Both negatively impacts the separation efficiency of the split tube 8. This tendency is suggested schematically by means of the arrows, which point in the direction of the split tube 8 in FIG. 2. Even though grinding bodies can also be discharged from the separation chamber 9 through the apertures 104, it is the tendency of the grinding bodies, however, to rather move towards the split tube 8.

The DE 44 12 408 C2 describes an agitator mill comprising a grinding container, which encloses a grinding chamber, which can be partially filled with auxiliary grinding bodies and through which grinding material can flow mainly axially, an agitator shaft, which supports agitating elements, which are arranged axially one behind the other, an outlet body, which is connected upstream of a grinding material outlet (48) of the grinding container, and a preliminary classification means, which has a preclassifying disk arranged directly in front of the outlet body comprising an axial passage and which preferably conveys auxiliary grinding bodies, which have reached into its effective region, radially to the outside, characterized in that the preclassification disk is simultaneously part of a rotating cage, which largely encloses the outlet body so that the latter is reachable for a significant portion of the grinding material through the preclassification disk.

### SUMMARY

In view of this, it is the object of the invention to further improve the separation performance of the split tube.

According to the invention, this problem is solved with the features of the first main claim.

For this purpose, an agitator mill comprising a grinding chamber including grinding bodies and an agitator shaft, which revolves therein about a horizontal agitator shaft axis, is assumed. The agitator shaft supports several grinding members, which are connected to it in a rotationally fixed manner, and which are spaced apart from one another in the direction of the horizontal axis. These grinding members are preferably formed in the shape of grinding disks. During the operation of the agitator mill, they move the above-described grinding bodies.

On the outlet side, the agitator shaft has a basket thereby. This means that the basket preferably follows the agitator shaft directly and is connected directly or indirectly thereto. However, the agitator shaft and the basket are thereby preferably not formed integrally with one another, which is why agitator shaft and basket represent two individual parts, and the agitator shaft does not take over any direct tasks of the basket. In addition, the length of the basket is preferably maximally one third, particularly preferably even maximally one fourth of the length of the agitator shaft.

The basket is preferably studded with additional grinding members on its outer circumference. As already mentioned, not only an additional grinding effect can be attained thereby in the radial circumferential region between the outer circumference of the basket and the inner wall of the grinding container. In fact, that circling movement of the grinding bodies, which promotes the reemergence of the grinding bodies from the separation chamber, is in particular also created thereby. These grinding members on the basket are thereby preferably not embodied like the grinding members of the agitator shaft. While the grinding members of the agitator shaft are preferably embodied in the shape of grinding disks, the grinding members of the basket are preferably embodied in the shape of pins.

In the operation as intended, this mentioned basket at least partially overlaps the outlet, whereby the outlet supports the split tube. It is preferably the case that the basket overlaps the split tube in its entire length. As part of these embodiments, the “split tube” in the narrower sense is preferably a tube comprising various slits and/or apertures of some other shapes, in the broader sense, however, the term “split tube” comprises any type of screen body.

As already described in a previous paragraph, a free region between the inner surface of the basket and the outer surface of the outlet or of the split tube, respectively, which is supported by the outlet, is formed by means of this overlapping arrangement of the basket. This region is referred to as “separation chamber”.

The agitator mill according to the invention is characterized in that the mentioned basket has slits for returning grinding bodies from the separation chamber into the grinding chamber. These slits are designed so that they lead into the free front surface of the basket, which faces away from the grinding chamber.

This is based on the following insight of the inventors: The entrance region shown by FIG. 2 directly behind the free front surface of the basket, in which the flow flows in predominantly horizontal direction in order to enter into the separation chamber, forms a constriction, which is too pronounced. The latter is so because the basket shown in FIG. 2 forms an annular structure, which is closed in the circumferential direction, in this region.

Even though the grinding body flow theoretically attains a higher flow speed when flowing through the constriction, which would in fact be desirable, the grinding bodies are entrained in particular in the axial direction and additionally have only limited options for leaving the basket. The grinding bodies thus often crash against the basket and/or the split tube, whereby they are decelerated strongly. In addition, the constriction is often also designed to be so narrow that some grinding bodies already collide with themselves, the basket and/or the split tube at the entrance into the separation chamber and thus already initially lose kinetic energy.

When the grinding bodies finally reach the outer circumferential surface of the split tube under the apertures, they often still only have a kinetic energy, which is too low in order to evade the suction of the split tube and to use the apertures to reemerge into the grinding chamber. A portion of the grinding bodies thus comes to a standstill and accumulates on the outer circumferential surface of the split tube. The grinding body dynamics is further reduced thereby. Under unfavorable circumstances, the split tube is in danger of being blocked after some operating time.

The mentioned “grinding chamber” is that chamber in the interior of the grinding container, which lies between inlet and outlet, and which is filled with grinding bodies and/or grinding material or grinding material suspension, respectively, and which is simultaneously not enclosed by the basket. The grinding chamber is thus quasi the interior of the grinding container, minus the built-in components passing through it and minus the separation chamber.

The slits molded according to the invention thus have the result that the radial gap between inner surface of the basket and outer surface of the outlet or split tube, respectively, which is to be passed in the course of the flow entrance into the separation chamber, is significantly enlarged at least regionally. An “accumulation” of the grinding bodies and/or of the material to be ground or of the grinding material suspension, respectively, at the entrance to the basket is reduced and/or a guiding of the grinding bodies towards the screen is prevented and the grinding bodies can, at least partially, enter into the separation chamber significantly more easily and with higher dynamics. A desirable flow is then created there, whereby the grinding bodies are rather kept away from the split tube and are carried out more quickly and/or more easily again from the separation chamber into the grinding chamber through the slits.

The split tube is blocked less strongly thereby and experiences less stress and/or or less wear because the grinding bodies are guided back into the grinding chamber more quickly and/or in a way, which is gentler for the split tube. Additional turbulences are created essentially in the region, in which the grinding bodies are entered directly through the slits (in particular in the region between outer circumference of the basket and the inner wall of the grinding container), and the surrounding grinding body bed is activated.

An increased grinding effect of the agitator mill can thus generally be attained, the split tube experiences a lower wear during operation, and fewer grinding bodies settle in or on the split tube. The agitator mill can thus be operated with a higher throughput with increased service life of the basket and with lower maintenance effort.

The “slits” are thereby apertures and/or openings and/or notches with an elongated shape as a whole, which are provided in or on the basket. A slit according to the invention thereby provides an aperture of the outer surface of the basket to the grinding chamber at least in one region, but preferably not over the entire length of the slit. Material can thus regionally adjoin the slit, whereby the slit is quasi “covered”, “lined” and/or surrounded by the material of the basket.

In addition, a slit according to the invention preferably does not have the same cross section over its entire length and can regionally change its expansion and/or its shape.

As part of the mentioned “coverage” of a slit of the basket, it should additionally also be mentioned here that it is preferred that a basket according to the invention is embodied so that each slit has, on its side facing away from the grinding chamber, material regionally adjoining the slit directly radial to the outside and thus above the slit. The slit is thus embodied to be “covered”, whereby an “end ring” forms in this region, which forms a preferably continuous circumferential surface.

This is necessary in order to stabilize the basket and to avoid vibrations. Each slit thus tunnels under the end ring.

There is a number of options for designing the invention so that its effectiveness or usability is even further improved.

A preferred embodiment of the invention is that the slits also pass through the wheel disk, which connects the basket to the agitator shaft, so that the respective slit is also connected to the grinding chamber via the wheel disk itself. The grinding bodies are thus given the opportunity to reach from the separation chamber into the grinding chamber even via this wheel disk, promoted by the grinding body dynamics running in the grinding chamber on the other side of the wheel disk. The discharge of the grinding bodies from the separation chamber is additionally simplified thereby.

It is furthermore particularly preferred that the slits tunnel under a stabilization ring, which is formed on the side or in the region, respectively, of the free end of the basket facing away from the grinding chamber. This stabilization ring is preferably embodied so that it protrudes further into the grinding chamber than the remaining diameter of the basket, radially to the outside, whereby the stability of the basket is increased on the one hand and the flow guidance or dynamics, respectively, is improved even further on the other hand.

A further preferred embodiment is that the main axes of the slits extend completely or at least essentially parallel to the agitator shaft axis. This is attained when these main axes deviate from the agitator shaft axis by maximally 10°, preferably maximally 5°. The main axes thereby run along the entire length of the slit, thus its entire length of expansion, preferably also parallel to the longitudinal axis of the basket and are located in the center of the slit and thus at half of the width of the slit.

It is furthermore particularly preferred when the flanks of the slits, which advance in the working direction of rotation, have an angle of attack of 0° to 45° with respect to the imaginary radial through their main axis. “Surfaces with a scooping effect”, which have the result that the grinding bodies are deflected and are thus discharged even better, quasi form on the basket in this way.

### BRIEF DESCRIPTION OF THE DRAWINGS

FIG. 1 shows an agitator mill according to the prior art from cut side view.

FIG. 2 shows the grinding container of an agitator mill from cut side view, whereby the basket has apertures for house-internal considerations.

FIG. 3 shows a first exemplary embodiment of the basket according to the invention in side view.

FIG. 4 shows the exemplary embodiment of the basket according to the invention from FIG. 3 in three-dimensional view.

FIG. 5 shows the exemplary embodiment of the basket according to the invention from FIG. 3 in front view.

FIG. 6 shows a second exemplary embodiment of the basket according to the invention comprising stabilization ring in three-dimensional view.

FIG. 7 shows the exemplary embodiment of the basket according to the invention comprising stabilization ring from FIG. 6 in side view.

FIG. 8 shows the exemplary embodiment of the basket according to the invention comprising stabilization ring from FIG. 6 in cut side view, whereby the basket encompasses a split tube-supporting outlet.

FIG. 9 shows the grinding container of an agitator mill from cut side view with a third exemplary embodiment of the basket according to the invention comprising another stabilization ring shape.

FIG. 10 shows a fourth exemplary embodiment of the basket according to the invention in side view.

FIG. 11 shows the exemplary embodiment of the basket according to the invention from FIG. 10 in three-dimensional view.

FIG. 12 shows a fifth exemplary embodiment of the basket according to the invention in front view.

FIG. 13 shows the exemplary embodiment of the basket according to the invention from FIG. 12 in three-dimensional view.

FIG. 14 shows a sixth exemplary embodiment of the basket according to the invention in front view.

FIG. 15 shows the exemplary embodiment of the basket according to the invention from FIG. 14 in three-dimensional view.

### DETAILED DESCRIPTION

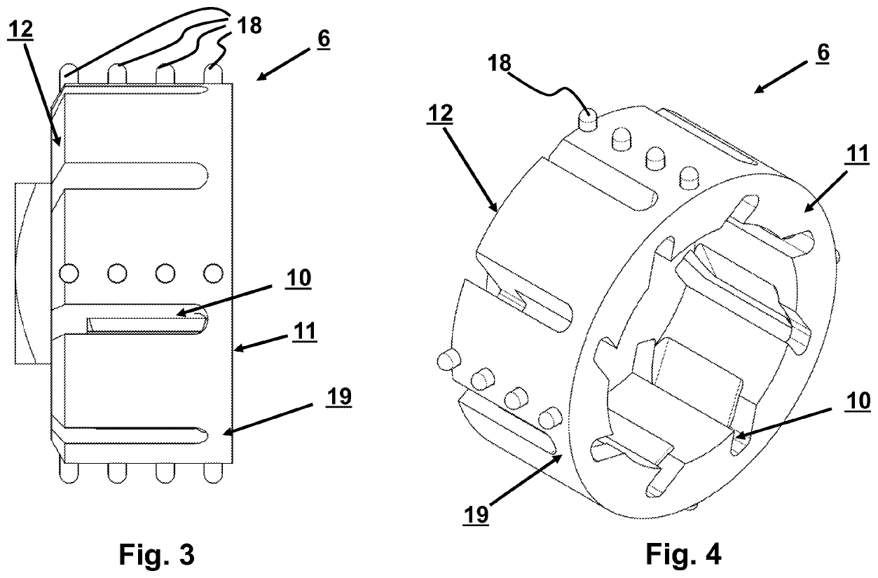

FIG. 3 to FIG. 5 initially show a first preferred exemplary embodiment of the basket 6 according to the invention in different views. On its outer circumference, the basket 6 is thereby studded with additional grinding members 18, which are attached regularly over the circumference of the basket 6 in the shape of pins in horizontal rows, which run parallel to the agitator shaft axis 4. The slits 10 are likewise regularly distributed over the circumference of the basket 6 and intersect the wheel disk 12 facing the grinding chamber 2 as well as the front surface 11 facing away from the grinding chamber 2, as mentioned. It can be favorable when one of said rows is not assigned to each individual slit 10, but when directly adjacent slits are present, the connecting region of which does not support any of said rows. On the side facing the front surface 11, the slit 10 additionally tunnels under the end ring 19, whereby the end ring 19 is embodied to be closed circumferentially.

For simplification and better overview, not every slit and not every grinding member is provided with reference numerals here and in the further figures, but only one slit and only one or two grinding members in an exemplary manner.

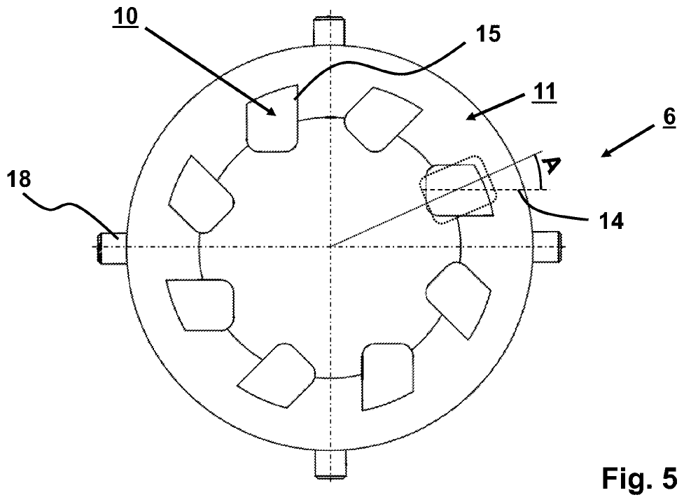

The front view of the basket 6 is illustrated in FIG. 5, looking onto the front surface 11 facing away from the grinding chamber here. The angle of attack A of the slits can be seen here, which has the result that the flanks 15 of the slits 10, which advance in the working direction of rotation or the imaginary extensions thereof, respectively, do not radially stand perpendicularly to the outer contour of the basket 6. This angle of attack A preferably lies between 0° and 45°. For better visualization, an imaginary slit can additionally be seen in a dashed manner, which stands precisely radially perpendicularly to the outer contour of the basket 6. From the main axis of a slit of this type, the angle is plotted to the main axis 14 of a slit 10 according to the invention, which corresponds to the angle of attack A.

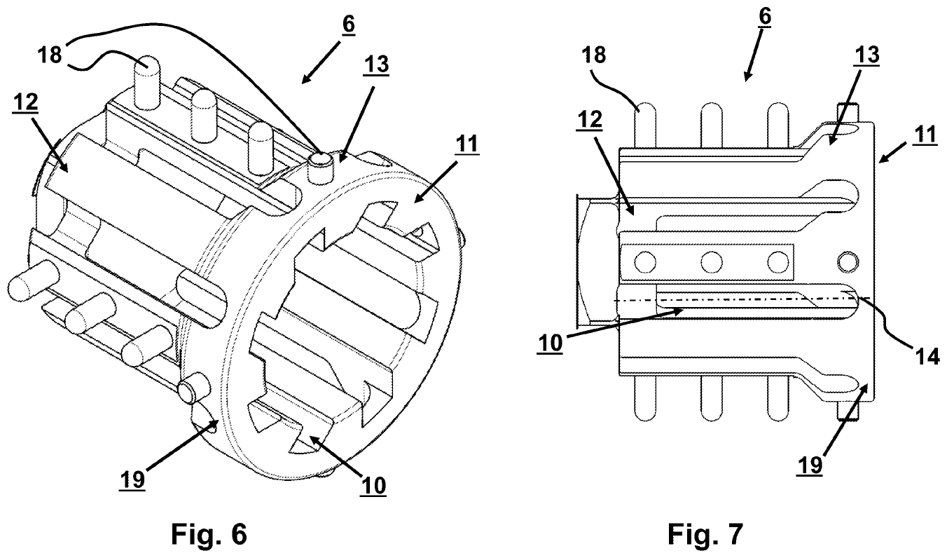

FIG. 6 to FIG. 8 show a second preferred embodiment of the basket 6, whereby the basket 6 supports a stabilization ring 13 with increased outer diameter. The slits 10, in turn, additionally tunnel under an end ring 19 on the side facing the front surface 11, whereby the end ring 19 is part of the stabilization ring 13 thereby. The slits 10 preferably likewise run through the wheel disk 12 here and the front surface 11 facing the grinding chamber. The basket 6 is likewise studded with additional grinding members 18, whereby the above statements also apply here. The stabilization ring itself can also be provided with additional grinding members 18, in particular with protruding pins or other agitators, which entrain the grinding bodies in the circumferential direction. The pins of the stabilization ring are preferably arranged so as to be aligned with the other pins of the basket, which have already been described above, mostly parallel to the agitator shaft axis 4, see FIGS. 6 and 7.

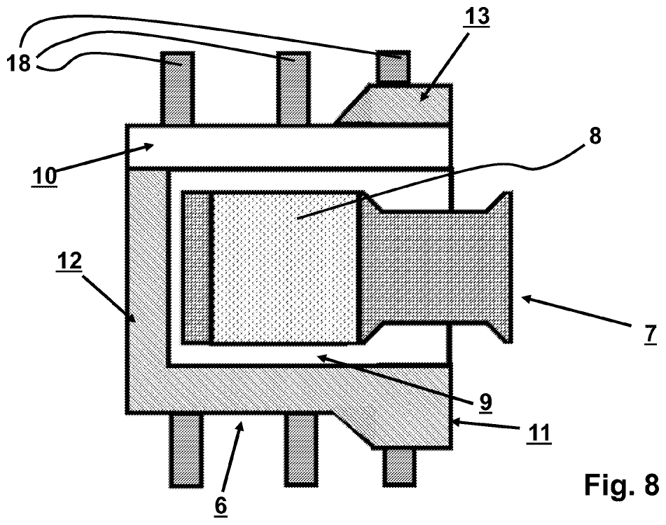

For better overview, a basket 6 formed in this way is illustrated in FIG. 8 in its preferred installation position, in which it encompasses an outlet 7, which supports a split tube 8. It can be favorable when the outlet 7 has a constriction (as designed here in a “spool-like manner” and optionally equipped with run-in and run-off slopes), which is arranged so that the gap, via which the inflow into the separation chamber 9 takes place, is enlarged by it. Even if such a constriction does not develop any “scooping” effect whatsoever in the circumferential direction, in contrast to the slits or apertures, respectively, according to the invention, and thus causes a different dynamic, it can nonetheless help to intensify the effect, which is to be attained according to the invention, in particular in synergistic cooperation with the slits or apertures according to the invention.

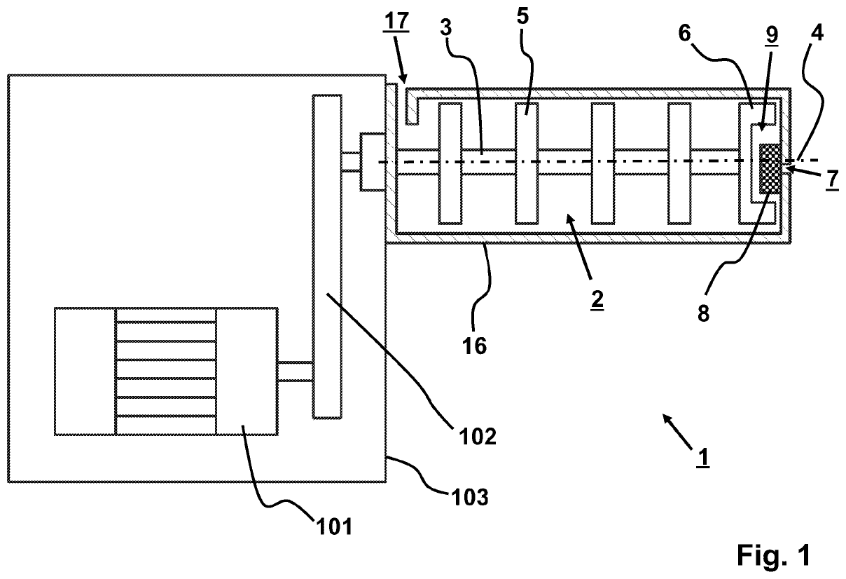

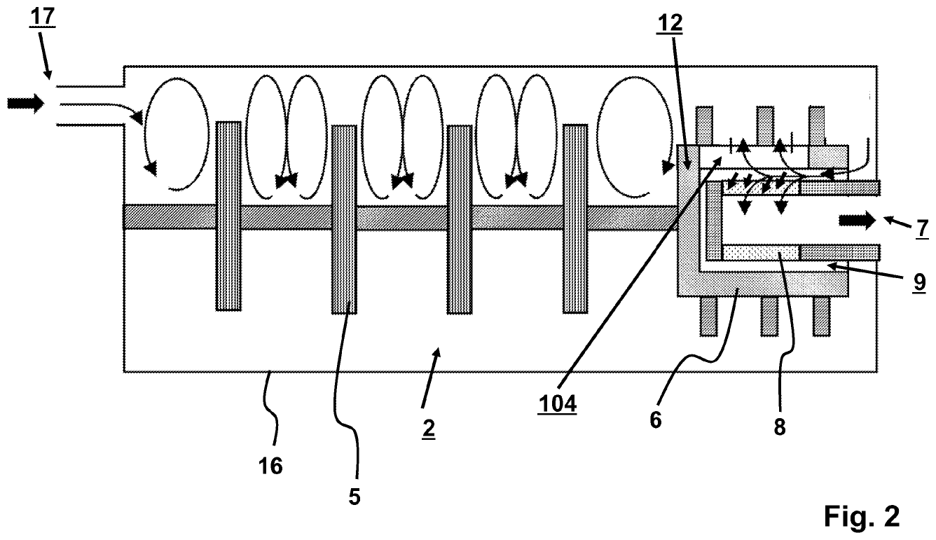

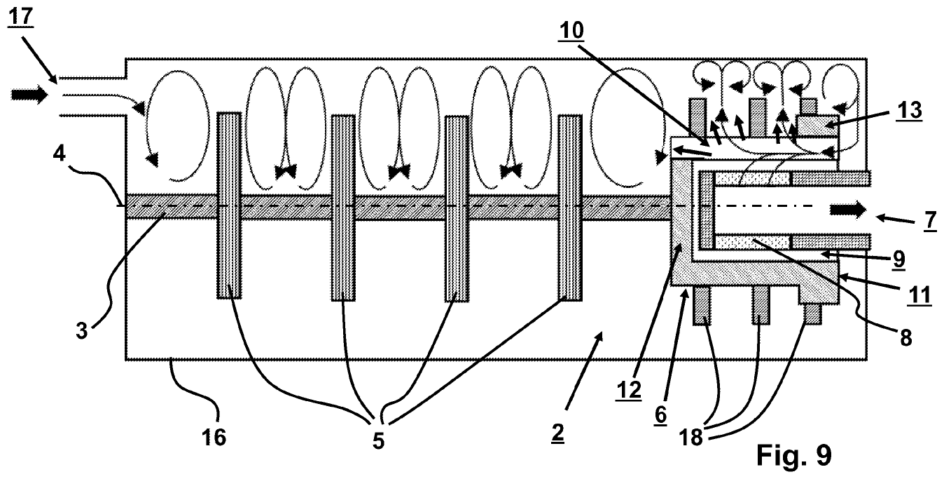

Lastly, FIG. 9 shows a further preferred embodiment of the basket 6, whereby the basket 6 likewise supports a stabilization ring 13, which, however, has a pure shape of a portion of a cylinder. The slits 10 tunnel under the entire stabilization ring 13 here, which thus quasi simultaneously acts as end ring. In addition, FIG. 9 schematically shows the flow behavior in the grinding container 16 of an agitator mill 1. Reference is made at this point to the general mode of operation of an agitator mill, which has been described in the paragraph “Technical Field” with the help of FIG. 1 and FIG. 2. The basic function and the flow behavior all the way to the region of the basket 6 is identical or similar, respectively, and will thus not be repeated once again at this point. The basket 6 illustrated in FIG. 9, however, has slits 10, which intersect the wheel disk 12 as well as the front surface 11 facing away from the grinding chamber. Grinding bodies and/or the grinding material suspension can thereby enter into the separation chamber 9 more easily, and especially the grinding bodies are discharged again from the separation chamber 9 into the grinding chamber 2 through the slits by means of the flow formed thereby, which is hereby also simplified via the additional connection to the grinding chamber via the partially slit wheel disk 12. The grinding bodies are thus kept away from the split tube 8 or the split tube-supporting outlet 7, respectively, and lead to an increased grinding effect in the grinding chamber 2 after the discharge from the separation chamber 9.

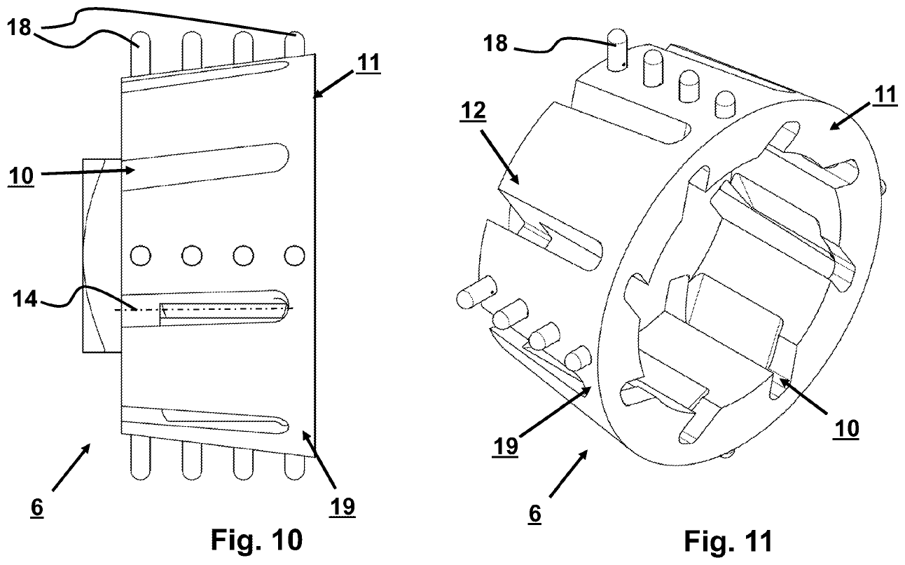

FIG. 10 and FIG. 11 furthermore show a further preferred embodiment of the basket 6 comprising slits 10 and additional grinding members 18, whereby the outer contour of the basket 6 is formed here in the shape of a truncated cone. Due to this design, a flow obstacle is avoided when flowing over the conical structure (in contrast to FIG. 9), and a dynamics of the flow, which increases continuously in the course of flowing over the basket, is attained. In the region of its free front end, the conical structure simultaneously quasi forms an integral stabilization ring, in the region of which an abrupt constriction does in fact not take place. The slits 10, in turn, thereby tunnel under a circumferentially closed end ring 19.

It can be seen well on the basis of FIG. 11 that the basket forms a cylindrical inner circumferential jacket surface on the inside, so that the separation chamber 9 in particular does not taper conically (coming from the free front surface of the basket). This would be unproductive due to the fact that there would be the risk in the case of a conical separation chamber that grinding bodies get jammed after entering into the separation chamber due to the conical inner profile.

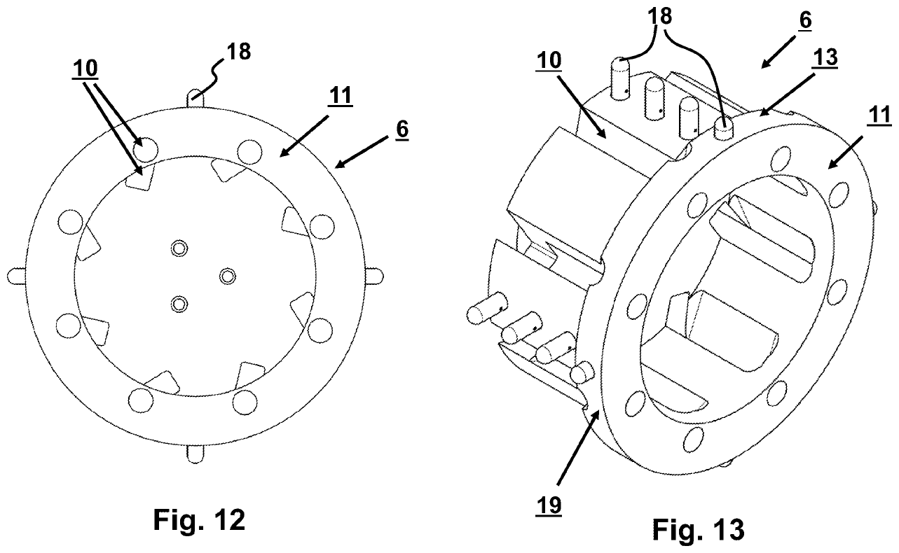

FIG. 12 and FIG. 13 show a further preferred embodiment of the basket 6. Said embodiment also has a stabilization ring 13 and the slits 10 tunnel under an end ring 19. However, the slits 10 run or are designed here, respectively, so that they pass through the front surface 11 only by means of a circular bore.

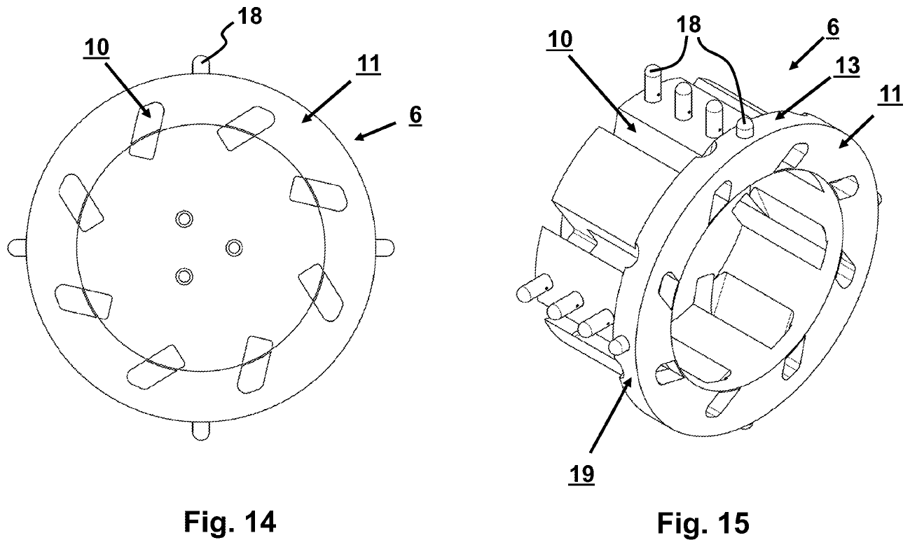

FIG. 14 and FIG. 15 show a further preferred embodiment of the basket 6. Said embodiment also has a stabilization ring 13 and the slits 10 tunnel under an end ring 19. However, the slits 10 run or are designed here, respectively, so that, in the region of the front surface 11 or on the side facing the front surface 11, respectively, they have a region, where material is provided directly below the slits 10, whereby the slits 10 are regionally quasi “lined”.

1. An agitator mill comprising a grinding chamber including grinding bodies and an agitator shaft, which revolves therein about a horizontal agitator shaft axis, which supports several grinding members, which are connected to it in a rotationally fixed manner and which are spaced apart from one another in the direction of the horizontal axis, preferably in the shape of grinding disks, which move the grinding bodies, whereby, on the outlet side, the agitator shaft has a basket, which is preferably studded with grinding members on its outer circumference and which overlaps the split tube-supporting outlet, whereby a separation chamber is formed between the inner surface of the basket and the split tube-supporting outlet, wherein the basket has slits for returning grinding bodies from the separation chamber into the grinding chamber, which slits lead into the free front surface of the basket, which faces away from the grinding chamber, whereby the slits change their expansion and/or shape at least regionally.

2. The agitator mill according to claim 1, wherein the slits also pass through the wheel disk, which connects the basket to the agitator shaft, so that the respective slit is also connected to the grinding chamber via the wheel disk itself.

3. The agitator mill according to claim 1, wherein slits tunnel under a stabilization ring, which is formed on the side or in the region, respectively, of the free end of the basket.

4. The agitator mill according to claim 1, wherein the maim axes of the slits extend parallel to the agitator shaft axis.

5. The agitator mill according to claim 4, wherein the flanks of the slits, which advance in the working direction of rotation, have an angle of attack of 0° to 45° with respect to the imaginary radial through their main axis.

6. A basket, which is preferably studded with grinding members on its outer circumference and which overlaps a split tube-supporting outlet, wherein the basket comprising slits, which lead into a free front surface of the basket, which faces away from a grinding chamber, whereby the slits change their expansion and/or shape at least regionally.

7. The agitator mill according to claim 2, wherein slits tunnel under a stabilization ring, which is formed on the side or in the region, respectively, of the free end of the basket.

8. The agitator mill according to claim 2, wherein the maim axes of the slits extend parallel to the agitator shaft axis.
